(19) United States
(12) Patent Application Publication
(10) Pub. No.: US 2022/0328815 A1
(43) Pub. Date: Oct. 13, 2022

(54) ALL-SOLID-STATE BATTERY

(71) Applicant: TOYOTA JIDOSHA KABUSHIKI KAISHA, Toyota-shi Aichi-ken (JP)

(72) Inventor: Ryouichi Kato, Tokai-shi Aichi-ken (JP)

(21) Appl. No.: 17/712,568

(22) Filed: Apr. 4, 2022

(30) Foreign Application Priority Data
Apr. 12, 2021 (JP) 2021-067222

(51) Int. Cl. H01M 4/38; H01M 10/0562; H01M 4/04; H01M 10/0525

(52) U.S. Cl. CPC H01M 4/386; H01M 10/0562; H01M 4/0407; H01M 10/0525

(57) ABSTRACT

Provided is an all-solid-state battery that makes it possible to suppress increase in resistance due to charge and discharge thereof even when the battery includes a Si-based active material for an anode active material. The all-solid-state battery has a cathode, an anode, and a solid electrolyte layer disposed between the cathode and the anode, wherein the anode contains a Si-based active material, and 2≤x≤2.7 and 21.43x+14.14≤y≤4.29x+60.43 where x represents the ratio of the anode capacity to the cathode capacity and y represents the fill factor of the anode.

### CROSS REFERENCE TO RELATED APPLICATION

This application claims priority to Japanese Patent Application No. 2021-067222, filed on Apr. 12, 2021, the entire contents of which are incorporated by reference herein.

### FIELD

The present application relates to an all-solid-state battery.

### BACKGROUND

Patent Literature 1 discloses an all-solid battery having a positive electrode layer, a negative electrode layer, and a solid electrolyte layer formed between the positive and negative electrode layers, wherein the positive electrode layer contains a positive electrode active substance having a composition represented by LiₓNiₐCo_{b}Mn_{c}O_{y} (1.15≤x≤1.55, a+b+c=1, 0≤a≤0.85, 0≤b≤0.85, 0.15≤c≤0.70, and y is a value determined to meet charge neutrality), the negative electrode layer contains a Si-based active substance, 2≤A≤5.5 is satisfied where A is the capacity ratio of the negative electrode capacity to the positive electrode capacity, and 0.1083A+0.9085≤Li/Me is satisfied where Li/Me is the mole ratio of Li to Me (Me is a metal element other than Li) in the positive electrode active substance.

### CITATION LIST

### Patent Literature

Patent Literature 1: JP 2020-4685 A

### SUMMARY

### Technical Problem

The resistance of an all-solid-state battery including a Si-based active material as an anode active material and an anode formed to have a high fill factor increases following charge and discharge thereof, which is problematic. This phenomenon is because the volume of a Si-based active material largely increases and decreases due to charging and discharging, which causes many cracks in an anode when the anode is formed to have a high fill factor.

Conventionally, LTO (lithium titanate) has been used for an anode active material in order to avoid such a problem. The volume of LTO hardly increases and decreases due to charging and discharging, and thus cracks as described above hardly appear. A higher ratio of the anode capacity/the cathode capacity makes it also possible to suppress cracks. In any case however, there is a problem of lowering energy density.

In view of the above circumstances, an object of the present application is to provide an all-solid-state battery that makes it possible to suppress increase in resistance due to charge and discharge thereof even when including a Si-based active material for an anode active material.

### Solution to Problem

As one aspect to solve the above problem, the present disclosure is provided with an all-solid-state battery having a cathode, an anode, and a solid electrolyte layer disposed between the cathode and the anode, wherein the anode contains a Si-based active material, 2≤x≤2.7 and 21.43x+14.14 y 4.29x+60.43 where x represents the ratio of the anode capacity to the cathode capacity and y represents the fill factor of the anode.

### Advantageous Effects

An all-solid-state battery according to the present disclosure makes it possible to suppress increase in resistance due to charge and discharge thereof even when including a Si-based active material for an anode active material.

### BRIEF DESCRIPTION OF DRAWINGS

FIG. 1 is a schematic cross-sectional view of an all-solid-state battery 100; FIG. 2 shows the relationship between the fill factor of an anode and the resistance increase ratio in each test example;

FIG. 3 shows the relationship between the fill factor of the anode and the resistance after a durability test in each test example; and

FIG. 4 explanatorily shows calculation of a fill factor y.

### DETAILED DESCRIPTION

An all-solid-state battery according to the present disclosure has a cathode, an anode, and a solid electrolyte layer disposed between the cathode and the anode, wherein the anode contains a Si-based active material, 2≤x≤2.7 and 21.43x+14.14≤y≤4.29x+60.43 where x represents the ratio of the anode capacity to the cathode capacity and y represents the fill factor of the anode.

As described above, the volume of a Si-based active material used for an anode active material largely increases and decreases due to charging and discharging, which may cause cracks in an anode. Cracks as described above more notably appear when the anode has a higher fill factor because there is less escape of the increased volume of the expanded anode active material as the fill factor is higher, and the anode fractures when stress of such expansion exceeds the strength of the anode, which causes many large cracks. Such cracks cut off an electron conduction path and an ion conduction path, to increase the resistance.

As described above, a higher ratio of the anode capacity/the cathode capacity may be considered for suppressing such cracks. In this case, however, there is a problem of lowering energy density. A lower fill factor of the anode may be also considered because a lower fill factor of the anode permits the escape of an expanded portion of the Si-based active material into voids in the anode, which makes it possible to relax stress generated in the anode, and to suppress cracks. However, too low a fill factor may lead to a weak contact force and a small contact area between the particles, to increase the contact resistance.

A feature of the all-solid-state battery according to the present disclosure is that 2≤x≤2.7 and 21.43x+14.14≤y≤4.29x+60.43 where x represents the ratio (capacity ratio) of the anode capacity to the cathode capacity and y represents the fill factor of the anode. Even when the capacity ratio x is as small as at most 2.7 as described above, control on the fill factor y to be in the above range makes it possible to suppress the resistance to be equal to or lower than that when LTO is used for the anode active material. The capacity ratio x at least 2 makes it possible to secure strength with which the expansion of the Si-based active material can be borne. In other words, when the capacity ratio is lower than 2, the structure of the electrode cannot bear the expansion of the Si active material per unit weight and it is difficult to suppress increase in resistance due to charging and discharging even if the fill factor is lowered.

From the foregoing, the all-solid-state battery according to the present disclosure makes it possible to suppress increase in resistance due to charge and discharge thereof even when including a Si-based active material for the anode active material.

<All-Solid-State Battery 100>

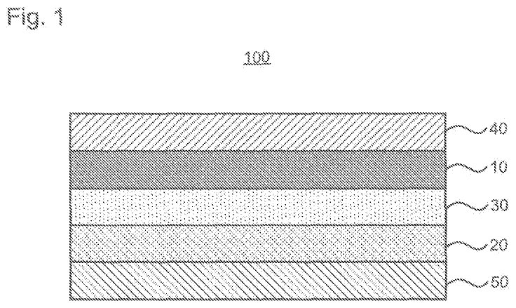

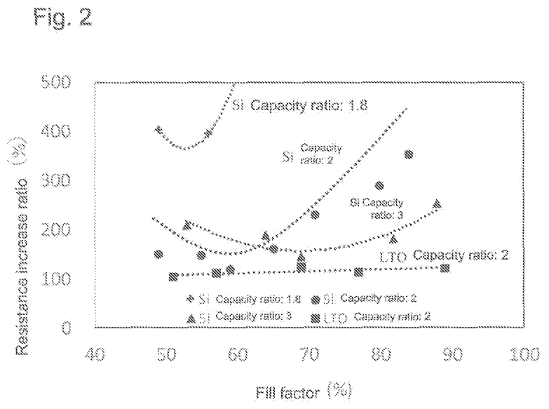

Hereinafter the all-solid-state battery according to the present disclosure will be described with an all-solid-state battery 100 that is one embodiment. FIG. 1 is a schematic cross-sectional view of the all-solid-state battery 100.

As in FIG. 1, the all-solid-state battery 100 has a cathode 10, an anode 20, and a solid electrolyte layer 30 disposed between the cathode and the anode. The all-solid-state battery 100 is also provided with a cathode current collector 40 and an anode current collector 50. Here, the all-solid-state battery 100 is an all-solid-state lithium ion battery.

(Cathode 10)

The cathode 10 contains a cathode active material. Any known cathode active material that may be used for all-solid-state batteries may be used as the cathode active material. Examples of the cathode active material include lithium-containing composite oxides such as lithium cobaltate and lithium nickelate. The particle diameter of the cathode active material is not particularly limited, but for example, ranges from 1 to 50 μm. The cathode 10 contains the cathode active material in the range of, for example, 50 wt % and 99 wt %. The surface of the cathode active material may be coated with an oxide layer such as a lithium niobate layer, a lithium titanate layer and a lithium phosphate layer.

Here, in the present description, a “particle diameter” means a particle diameter (D₅₀) at a 50% integrated value in a volume-based particle diameter distribution that is measured using a laser diffraction and scattering method.

The cathode 10 may optionally contain a solid electrolyte. Examples of the solid electrolyte include oxide solid electrolytes and sulfide solid electrolytes. In embodiments, the solid electrolyte may comprise sulfide solid electrolytes. Examples of oxide solid electrolytes include Li₇La₃Zr₂O₁₂, Li₇₋ₓLa₃Zr₁₋ₓNbₓO₁₂, Li₃PO₄, and Li₃₊xPO₄₋ₓNₓ (LiPON).

Examples of sulfide solid electrolytes include Li₃PS₄, Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—PO₂O₅, LiI—Li₃PO₄—P₂S₅, and Li₂S—P₂S₅—GeS₂. The content of the solid electrolyte in the cathode 10 is not particularly limited. The cathode 10 contains the solid electrolyte in the range of, for example, 1 wt % and 50 wt %.

The cathode 10 may optionally contain a conductive aid. Examples of the conductive aid include carbon materials such as acetylene black, Ketjenblack, and vapor grown carbon fiber (VGCF), and metallic materials such as nickel, aluminum and stainless steel. The content of the conductive aid in the cathode 10 is not particularly limited. For example, the cathode 10 contains the conductive aid in the range of 0.1 wt % and 10 wt %.

The cathode 10 may optionally contain a binder. Examples of the binder include butadiene rubber (BR), styrene-butadiene rubber (SBR), butyl rubber (IIR), acrylate-butadiene rubber (ABR), polyvinylidene fluoride (PVdF), and polyvinylidene fluoride-hexafluoropropylene copolymer (PVDF-HFP). The content of the binder in the cathode 10 is not particularly limited. For example, the cathode 10 contains the binder in the range of 0.1 wt % and 10 wt %.

The thickness of the cathode 10 is not particularly limited, but may be suitably set according to a desired battery performance. For example, the thickness ranges from 0.1 μm to 1 mm.

There is no particular limitations on a method of manufacturing the cathode 10. The cathode 10 may be manufactured according to a known method. For example, one may mix and press-mold a material to constitute the cathode 10, to manufacture the cathode 10. Alternatively, one may mix a material to constitute the cathode 10 with a solvent to form a slurry, and apply and dry the slurry onto a substrate or the cathode current collector 40, to manufacture the cathode 10.

<Anode 20>

The anode 20 contains at least a Si-based anode active material. The Si-based active material is, in embodiments, an active material that can alloy with Li. Examples of the Si-based active material include a simple of Si, Si alloys, and Si oxides. Among Si alloys, a Si alloy containing a Si element as the main constituent is used in embodiments. When a Si alloy is used, for example, the proportion of a Si element in the Si alloy may be at least 50 mol %, may be at least 70 mol %, and may be at least 90 mol %. An example of Si oxides is SiO. The particle diameter of the Si-based active material is not particularly limited, but for example, ranges from 5 to 50 μm. The anode 20 contains the anode active material in the range of, for example, 30 wt % and 90 wt %.

The anode 20 may optionally contain a solid electrolyte. The solid electrolyte may be suitably selected from solid electrolytes that may be used in the cathode 10. The content of the solid electrolyte in the anode 20 is not particularly limited. The anode 20 contains the solid electrolyte in the range of, for example, 10 wt % and 70 wt %.

The anode 20 may optionally contain a conductive aid. The conductive aid may be suitably selected from conductive aids that may be used in the cathode 10. The content of the conductive aid in the anode 20 is not particularly limited. The anode 20 contains the conductive aid in the range of, for example, 0.1 wt % and 20 wt %.

The anode 20 may optionally contain a binder. The binder may be suitably selected from binders that may be used in the cathode 10. The content of the binder in the anode 20 is not particularly limited. The anode 20 contains the binder in the range of, for example, 0.1 wt % and 10 wt %.

The thickness of the anode 20 is not particularly limited, but may be suitably set according to a desired battery performance. For example, the thickness ranges from 0.1 μm to 1 mm.

There is no particular limitations on a method of manufacturing the anode 20. The anode 20 may be manufactured according to a known method. For example, one may employ the same way as any of the above described methods of manufacturing the cathode 10.

<Solid Electrolyte Layer 30>

The solid electrolyte layer 30 contains a solid electrolyte. The solid electrolyte may be suitably selected from solid electrolytes that may be used in the cathode 10. The content of the solid electrolyte in the solid electrolyte layer 30 is not particularly limited. The solid electrolyte layer 30 contains the solid electrolyte in the range of, for example, 50 wt % and 100 wt %.

The solid electrolyte layer 30 may optionally contain a binder. The binder may be suitably selected from binders that may be used in the cathode 10. The content of the binder in the solid electrolyte layer 30 is not particularly limited. The solid electrolyte layer 30 contains the binder in the range of, for example, 0.1 wt % and 10 wt %.

There is no particular limitations on a method of manufacturing the solid electrolyte layer 30. The solid electrolyte layer 30 may be manufactured according to a known method.

For example, one may employ the same way as any of the above described methods of manufacturing the cathode 10.

<Cathode Current Collector 40, Anode Current Collector 50>

The cathode current collector 40 and the anode current collector 50 may be made from a metal body, metal mesh, or the like. A metal body is used in embodiments.

Examples of a metal constituting the cathode current collector 40 and the anode current collector 50 include SUS, Al and Ni. The thickness of each of the cathode current collector 40 and the anode current collector 50 is not particularly limited, but may be the same as a conventional one. For example, the thickness ranges from 0.1 μm to 1 mm.

<All-Solid-State Battery 100>

As for the all-solid-state battery 100, 2≤x≤2.7 and 21.43x+14.14≤y≤4.29x+60.43 where x represents the ratio of the anode capacity to the cathode capacity (capacity ratio: the anode capacity/the cathode capacity) and y represents the fill factor of the anode, whereby the all-solid-state battery 100 makes it possible to suppress increase in resistance due to charge and discharge thereof. The capacity ratio x and the fill factor y were experimentally obtained from Examples described later.

The method of manufacturing the all-solid-state battery 100 is, for example, as follows. First, the cathode 10, the anode 20 and the solid electrolyte layer 30 are prepared. At this time, the cathode 10 and the anode 20 are conditioned, so that the capacity ratio x is in the above range. Then, they are stacked successively, and press-molded. At this time, the pressure for the press molding is adjusted, so that the fill factor y of the anode 20 is in the above range. Whereby the all-solid-state battery 100 can be obtained. Here, the fill factor y may be calculated from the thickness of the anode 20 and the amount of the anode mixture obtained when only the anode 20 is independently pressed. The obtained all-solid-state battery 100 may be sealed in a known outer casing of laminated film or the like.

### EXAMPLES

Hereinafter the all-solid-state battery according to the present disclosure will be further described with Examples.

[All-Solid-State Battery]

All-solid-state batteries according to Examples 1 to 2 and Comparative Examples 1 to 18 were prepared in the following ways.

### Example 1

### (Preparing Cathode Structure)

A cathode active material (LiNi_{1/3}Co_{1/3}Mn_{1/3}O₂, mean particle diameter: 10 μm) coated with LiNbO₃ with a tumbling fluidized bed granulating-coating machine, a sulfide solid electrolyte (10LiI.15LiBr.75(0.75Li₂S.0.25P₂S₅) (mol %), mean particle diameter: 0.5 μm), a conductive aid (VGCF-H), and a binder (SBR) were weighed, so that the weight ratio thereof was such that cathode active material:sulfide solid electrolyte:conductive aid:binder=85.4:12.7:1.3:0.6, and mixed with a dispersion medium (diisobutyl ketone). The obtained mixture was dispersed by means of an ultrasonic homogenizer (UH-50 manufactured by SMT Corporation), and the resultant cathode slurry was obtained. A cathode current collector (Al foil, thickness: 15 μm) was coated with the obtained cathode slurry by blade coating with an applicator, and dried at 100° C. for 30 minutes. Thereafter, a cathode structure having a cathode and the cathode current collector which had a size of 1 cm² was stamped out from the resultant, and thereby obtained.

(Preparing Anode Structure)

An anode active material (Si particle, mean particle diameter: 2.5 μm), a sulfide solid electrolyte (10LiI.15LiBr.75(0.75Li₂S.0.25P₂S₅) (mol %), mean particle diameter: 0.5 μm), a conductive aid (VGCF-H), and a binder (SBR) were weighed, so that the weight ratio thereof was such that anode active material:sulfide solid electrolyte: conductive aid:binder=62.1:31.7:5.0:1.2, and mixed with a dispersion medium (diisobutyl ketone). The obtained mixture was dispersed by means of an ultrasonic homogenizer (UH-50 manufactured by SMT Corporation), and the resultant anode slurry was obtained. An anode current collector (Ni foil, thickness: 22 μm) was coated with the obtained anode slurry by blade coating with an applicator, and dried at 100° C. for 30 minutes. The gap of the applicator at this time was adjusted, so that the ratio of the anode capacity/the cathode capacity (capacity ratio) was 2 when the cathode capacity was 207 mAh/g and the anode capacity was 3579 mAh/g. Thereafter, an anode structure having an anode layer and the anode current collector which had a size of 1 cm² was stamped out from the resultant, and thereby obtained.

(Preparing Solid Electrolyte Layer)

A sulfide solid electrolyte (10LiI.15LiBr.75(0.75Li₂S.0.25P₂S₅) (mol %), mean particle diameter: 2.0 μm), and a binder (SBR) were weighed, so that the weight ratio thereof was such that sulfide solid electrolyte:binder=99.6:0.4, and mixed with a dispersion medium (diisobutyl ketone). The obtained mixture was dispersed by means of an ultrasonic homogenizer (UH-50 manufactured by SMT Corporation), and the resultant slurry was obtained. A substrate (Al foil, thickness: 15 μm) was coated with the obtained slurry by blade coating with an applicator, and dried at 100° C. for 30 minutes. Thereafter, a solid electrolyte layer having Al foil which had a size of 1 cm² was stamped out from the resultant, and thereby obtained.

(Preparing All-Solid-State Battery)

The obtained solid electrolyte layer and cathode structure were laminated, so that the cathode and the solid electrolyte layer faced each other, and were pressed at a linear pressure of 1.6 t/cm according to a roll pressing method. Thereafter the Al foil was released from the solid electrolyte layer, whereby the solid electrolyte layer was transferred on the cathode. Next, the solid electrolyte layer transferred on the cathode, and the anode structure were laminated so as to face each other, to be subjected to pressing at a contact pressure of 5.0 t/cm² with a uniaxial press; and thereafter a tab for collecting a current was disposed on current collector foil of each of the cathode and the anode, to be laminated and sealed in; and the resultant all-solid-state battery was obtained. Here, the fill factor was calculated from the thickness of an anode structure and the weight of the mixture after this anode structure, which was independently prepared and was the same as the above anode structure, was pressed at the contact pressure same as the above.

### Example 2

An all-solid-state battery according to Example 2 was prepared in the same way as in Example 1 except that the contact pressure with the uniaxial press when the solid electrolyte layer and the anode structure were laminated was changed to 4.0 t/cm².

### Comparative Example 1

An all-solid-state battery according to Comparative Example 1 was prepared in the same way as in Example 1 except that the gap of the applicator when the anode structure was prepared was adjusted, so that the ratio of the anode capacity/the cathode capacity (capacity ratio) was 1.8, and that the contact pressure with the uniaxial press when the solid electrolyte layer and the anode structure were laminated was changed to 6.0 t/cm².

### Comparative Example 2

An all-solid-state battery according to Comparative Example 2 was prepared in the same way as in Comparative Example 1 except that the contact pressure with the uniaxial press when the solid electrolyte layer and the anode structure were laminated was changed to 4.0 t/cm².

### Comparative Example 3

An all-solid-state battery according to Comparative Example 3 was prepared in the same way as in Comparative Example 1 except that the contact pressure with the uniaxial press when the solid electrolyte layer and the anode structure were laminated was changed to 2.0 t/cm².

### Comparative Example 4

An all-solid-state battery according to Comparative Example 4 was prepared in the same way as in Example 1 except that the solid electrolyte layer and the anode structure were pressed at a linear pressure of 5.0 t/cm according to a roll pressing method when laminated.

### Comparative Example 5

An all-solid-state battery according to Comparative Example 5 was prepared in the same way as in Example 1 except that the contact pressure with the uniaxial press when the solid electrolyte layer and the anode structure were laminated was changed to 7.0 t/cm².

### Comparative Example 6

An all-solid-state battery according to Comparative Example 6 was prepared in the same way as in Example 1 except that the contact pressure with the uniaxial press when the solid electrolyte layer and the anode structure were laminated was changed to 6.0 t/cm².

### Comparative Example 7

An all-solid-state battery according to Comparative Example 7 was prepared in the same way as in Example 1 except that the contact pressure with the uniaxial press when the solid electrolyte layer and the anode structure were laminated was changed to 3.0 t/cm².

### Comparative Example 8

An all-solid-state battery according to Comparative Example 8 was prepared in the same way as in Example 1 except that the contact pressure with the uniaxial press when the solid electrolyte layer and the anode structure were laminated was changed to 2.0 t/cm².

### Comparative Example 9

An all-solid-state battery according to Comparative Example 9 was prepared in the same way as in Example 1 except that the gap of the applicator when the anode structure was prepared was adjusted, so that the ratio of the anode capacity/the cathode capacity (capacity ratio) was 3, and that the solid electrolyte layer and the anode structure were pressed at a linear pressure of 5.0 t/cm according to a roll pressing method when laminated.

### Comparative Example 10

An all-solid-state battery according to Comparative Example 10 was prepared in the same way as in Comparative Example 9 except that the solid electrolyte layer and the anode structure were subjected to pressing at a contact pressure of 7.0 t/cm² with the uniaxial press when laminated.

### Comparative Example 11

An all-solid-state battery according to Comparative Example 11 was prepared in the same way as in Comparative Example 9 except that the solid electrolyte layer and the anode structure were subjected to pressing at a contact pressure of 6.0 t/cm² with the uniaxial press when laminated.

### Comparative Example 12

An all-solid-state battery according to Comparative Example 12 was prepared in the same way as in Comparative Example 9 except that the solid electrolyte layer and the anode structure were subjected to pressing at a contact pressure of 5.0 t/cm² with the uniaxial press when laminated.

### Comparative Example 13

An all-solid-state battery according to Comparative Example 13 was prepared in the same way as in Comparative Example 9 except that the solid electrolyte layer and the anode structure were subjected to pressing at a contact pressure of 4.0 t/cm² with the uniaxial press when laminated.

### Comparative Example 14

An all-solid-state battery according to Comparative Example 14 was prepared in the same way as in Example 1 except that the step of preparing the anode structure was changed as follows, and that the solid electrolyte layer and the anode structure were subjected to pressing at a linear pressure of 5.0 t/cm according to a roll pressing method when laminated.

An anode active material (Li₄Ti₅O₁₂ (LTO), mean particle diameter: 0.8 μm), a sulfide solid electrolyte (10LiI.15LiBr.75 (0.75Li₂S.0.25P₂S₅) (mol %), mean particle diameter: 0.5 μm), a conductive aid (VGCF-H), and a binder (SBR) were weighed, so that the weight ratio thereof was such that anode active material:sulfide solid electrolyte: conductive aid:binder=71.0:23.9:2.5:3.4, and mixed with a dispersion medium (diisobutyl ketone). The obtained mixture was dispersed by means of an ultrasonic homogenizer (UH-50 manufactured by SMT Corporation), and the resultant anode slurry was obtained. An anode current collector (Ni foil, thickness: 22 μm) was coated with the obtained anode slurry by blade coating with an applicator, and dried at 100° C. for 30 minutes. The gap of the applicator at this time was adjusted, so that the ratio of the anode capacity/the cathode capacity was 3. Thereafter, an anode structure having an anode layer and the anode current collector which had a size of 1 cm² was stamped out from the resultant, and thereby obtained.

### Comparative Example 15

An all-solid-state battery according to Comparative Example 15 was prepared in the same way as in Comparative Example 14 except that the solid electrolyte layer and the anode structure were subjected to pressing at a contact pressure of 7.0 t/cm² with a uniaxial press when laminated.

### Comparative Example 16

An all-solid-state battery according to Comparative Example 16 was prepared in the same way as in Comparative Example 14 except that the solid electrolyte layer and the anode structure were subjected to pressing at a contact pressure of 6.0 t/cm² with a uniaxial press when laminated.

### Comparative Example 17

An all-solid-state battery according to Comparative Example 17 was prepared in the same way as in Comparative Example 14 except that the solid electrolyte layer and the anode structure were subjected to pressing at a contact pressure of 5.0 t/cm² with a uniaxial press when laminated.

### Comparative Example 18

An all-solid-state battery according to Comparative Example 18 was prepared in the same way as in Comparative Example 14 except that the solid electrolyte layer and the anode structure were subjected to pressing at a contact pressure of 4.0 t/cm² with a uniaxial press when laminated.

[Durability Test]

A durability test was done for each of Examples 1 to 2 and Comparative Examples 1 to 18 as follows. In each durability test, a cycle of charge and discharge was repeated 50 times: in the cycle for each of Comparative Examples 1 to 13 and Examples 1 and 2, the voltage ranged from 2.5 V to 4.05 V and the current was 3.67 mA; and in the cycle for each of Comparative Examples 14 to 18, the voltage ranged from 3.0 V to 4.35 V and the current was 2.32 mA. As the initial resistance of the battery according to each of Comparative Examples 1 to 13 and Examples 1 and 2, the resistance thereof was calculated from the voltage change when the cycle of charge and discharge in the same voltage range as in the durability test was repeated three times; thereafter the battery was charged once, and further discharged up to 3.0 V; and thereafter discharged at 6.2 mA for 10 seconds. As the initial resistance of the battery according to each of Comparative Examples 14 to 18, the resistance thereof was calculated from the voltage change when the cycle of charge and discharge in the same voltage range as in the durability test was repeated three times; thereafter the battery was charged once, and further discharged up to 3.2 V; and thereafter discharged at 3.9 mA for 10 seconds. The resistance of the battery according to each of Examples 1 and 2 and Comparative Examples 1 to 18 after the durability test was measured in the same way as for the initial resistance thereof after the above-identified cycle of charge and discharge was repeated 50 times. The results are shown in Table 1.

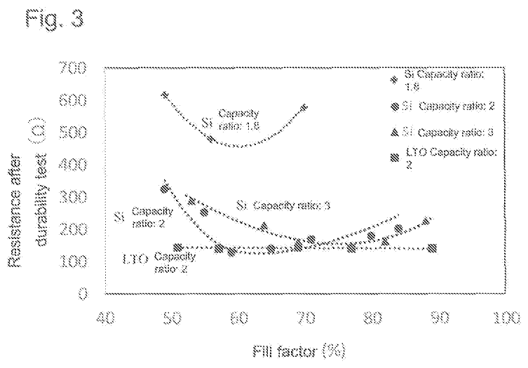

FIGS. 2 and 3 respectively show the relationship between the fill factor of the anode and the resistance increase ratio, and the relationship between the fill factor of the anode and the resistance after the durability test. Here, in FIGS. 2 and 3, Examples and Comparative Examples were classified into Test Examples by anode active material and by capacity ratio, and an approximate straight line or an approximate curve was used for each of Test Examples.

TABLE 1

| | Anode | | | Initial | Resistance | Resistance |
|---|---|---|---|---|---|---|
| | active | Capacity | Fill factor | resistance | after durability | increase |
| | material | ratio | (%) | (Ω) | test (Ω) | ratio (%) |
| Comparative | Si | 1.8 | 70 | 45 | 581 | 1191 |
| Example 1 | | | | | | |
| Comparative | Si | 1.8 | 56 | 97 | 480 | 395 |
| Example 2 | | | | | | |
| Comparative | Si | 1.8 | 49 | 123 | 620 | 404 |
| Example 3 | | | | | | |
| Comparative | Si | 2 | 84 | 45 | 203 | 352 |
| Example 4 | | | | | | |
| Comparative | Si | 2 | 80 | 47 | 183 | 289 |
| Example 5 | | | | | | |
| Comparative | Si | 2 | 71 | 51 | 169 | 231 |
| Example 6 | | | | | | |
| Example 1 | Si | 2 | 65 | 54 | 141 | 161 |
| Example 2 | Si | 2 | 59 | 60 | 131 | 118 |
| Comparative | Si | 2 | 55 | 102 | 253 | 148 |
| Example 7 | | | | | | |
| Comparative | Si | 2 | 49 | 130 | 326 | 151 |
| Example 8 | | | | | | |
| Comparative | Si | 3 | 88 | 64 | 227 | 252 |
| Example 9 | | | | | | |
| Comparative | Si | 3 | 82 | 58 | 163 | 180 |
| Example 10 | | | | | | |
| Comparative | Si | 3 | 69 | 66 | 160 | 144 |
| Example 11 | | | | | | |
| Comparative | Si | 3 | 64 | 74 | 213 | 189 |
| Example 12 | | | | | | |
| Comparative | Si | 3 | 53 | 94 | 290 | 210 |
| Example 13 | | | | | | |
| Comparative | LTO | 2 | 89 | 63 | 140 | 121 |
| Example 14 | | | | | | |
| Comparative | LTO | 2 | 77 | 66 | 141 | 114 |
| Example 15 | | | | | | |
| Comparative | LTO | 2 | 69 | 65 | 144 | 123 |
| Example 16 | | | | | | |
| Comparative | LTO | 2 | 57 | 68 | 143 | 111 |
| Example 17 | | | | | | |
| Comparative | LTO | 2 | 51 | 71 | 144 | 104 |
| Example 18 | | | | | | |

[Results]

The following can be considered in view of the results of Table 1, and FIGS. 2 and 3. In FIGS. 2 and 3, the resistance after the durability test hardly increased in Test Example where LTO was used. In contrast, the tendency of the resistance increase ratio and the tendency of the resistance after the durability test were different in capacity ratio in Test Examples where Si was used. Specifically, in Test Example where the capacity ratio was 1.8, the resistance after the durability test was notably high. On the contrary, in Test Examples where the capacity ratio was 2 and 3, the resistance after the durability test was suppressed when the fill factor was in a predetermined range. Further, in Test Example where the capacity ratio was 2, the resistance after the durability test was equal to or lower than that in Test Example where LTO was used when the fill factor was in a predetermined range. The foregoing Test Example is Examples 1 and 2 in the above description.

Next, from the results of FIG. 3, the range of the fill factor where the resistance after the durability test was equal to or lower than that when LTO was used even when the Si-based active material was used for the anode active material was estimated. Specifically, the following were examined using an approximate straight line based on Test Example where LTO was used (LTO approximate straight line), an approximate curve based on Test Example where Si was used and the capacity ratio was 2 (approximate curve 2), and an approximate curve based on Test Example where Si was used and the capacity ratio was 3 (approximate curve 3).

First, the points of the minimum values of the approximate curve 2 and the approximate curve 3 were connected by a straight line, and a point of intersection A of this straight line with the LTO approximate straight line was obtained. Assuming that the minimum value linearly changed when the capacity ratio ranged from 2 to 3, it could be estimated that the point of intersection A was the minimum value of an approximate curve when the capacity ratio was 2.7. In view of this result, it is believed to be important that 2×2.7 where x represents the capacity ratio in an all-solid-state battery containing a Si-based active material.

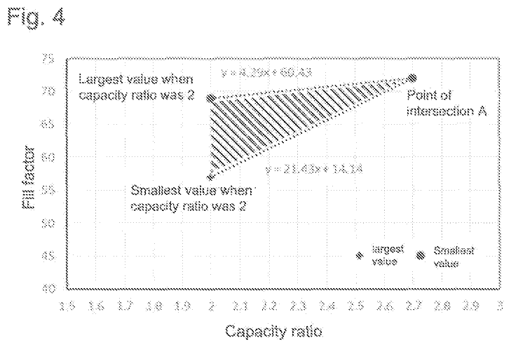

It was also estimated that as the capacity ratio increased, the minimum values of approximate curves with respect to both the fill factor and the resistance after the durability test increased. From this, it could be estimated that as the capacity ratio increased, the range of the fill factor where the resistance was lower than that of the LTO approximate curve narrowed. Thus, the range of the fill factor of the anode where the resistance was equal to or lower than that after the durability test in Test Example where LTO was used was calculated from the relationship between the fill factors at points of intersection of the LTO approximate straight line with the approximate curve 2, and the fill factor at the point of intersection A. Specifically, from the relationship between the capacity ratio and the fill factor, the relationship between the capacity ratio and the fill factor which satisfied the area formed by connecting the largest and smallest values of the fill factor when the fill factor of the approximate curve 2 was lower than that of the LTO approximate straight line, and the point of intersection A was calculated (see FIG. 4). As a result of this, it was found it is important that 21.43x+14.14≤y≤4.29x+60.43 where x represents the capacity ratio, and y represents the fill factor.

From the foregoing, it can be believed that in an all-solid-state battery containing a Si-based anode active material, 2≤x≤2.7 and 21.43x+14.14≤y≤4.29x+60.43 where x represents the capacity ratio and y represents the fill factor, whereby the resistance equal to or lower than that of an all-solid-state battery where LTO is used can be obtained after the durability test. That is, it is believed that in an all-solid-state battery using a Si-based anode active material, increase in resistance due to charge and discharge thereof can be suppressed.

### REFERENCE SIGNS LIST

10 cathode

20 anode

30 solid electrolyte layer

40 cathode current collector

50 anode current collector

100 all-solid-state battery

What is claimed is:

1. An all-solid-state battery having a cathode, an anode, and a solid electrolyte layer disposed between the cathode and the anode, wherein
the anode contains a Si-based active material, and
2≤x≤2.7 and 21.43x+14.14≤y≤4.29x+60.43 where x represents a ratio of an anode capacity to a cathode capacity and y represents a fill factor of the anode.
